(19) United States
(12) Patent Application Publication
(10) Pub. No.: US 2014/0183213 A1
(43) Pub. Date: Jul. 3, 2014

(54) VENDING MACHINE

(71) Applicant: HON HAI PRECISION INDUSTRY CO., LTD., New Taipei (TW)

(72) Inventor: YUN-LUNG CHEN, New Taipei (TW)

(73) Assignee: HON HAI PRECISION INDUSTRY CO., LTD., New Taipei (TW)

(21) Appl. No.: 14/043,954

(22) Filed: Oct. 2, 2013

(30) Foreign Application Priority Data
Dec. 27, 2012 (CN) 2012105775888

(51) Int. Cl. G07F 11/48

(52) U.S. Cl. CPC G07F 11/48
USPC 221/197

(57) ABSTRACT

A vending machine includes a rack, a pair of slides, and a tray. A first slideway and a second slideway are defined in each of the pair of slides. The first slideway communicates with the second slideway. A stop tab is located in the second slideway. The tray is movable along the pair of slides. The tray includes a block tab and an end post. The end post is movable from the first slideway to the second slideway. In the first slideway, the end post and the block tab are restricted, and the tray is substantially horizontal. In the second slideway, the stop tab blocks the block tab, the end post is lift up by the tray, and the tray is oblique.

### BACKGROUND

1. Technical Field

The disclosure generally relates to a vending machine, especially to a vending machine with a movable tray.

2. Description of Related Art

A vending machine is a machine which dispenses items such as snacks, beverages, and consumer products automatically. A present vending machine usually includes a plurality of trays for carrying goods. These trays are movable along a straight slideway from a rack of the vending machine to load the goods. However, a rear loading space of each tray remains in the rack when the each tray is moved to the end of the slideway. It is hard to load goods to the rear loading space of each tray. Therefore, there is need to improve within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of a vending machine in one embodiment.

FIG. 2 is an enlarged view of a circled portion II of the vending machine of FIG. 1.

FIG. 3 is an enlarged view of a circled portion III of the vending machine of FIG. 1.

FIG. 4 is an assembled view of the vending machine of FIG. 1.

FIG. 5 is a schematic view of the vending machine of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

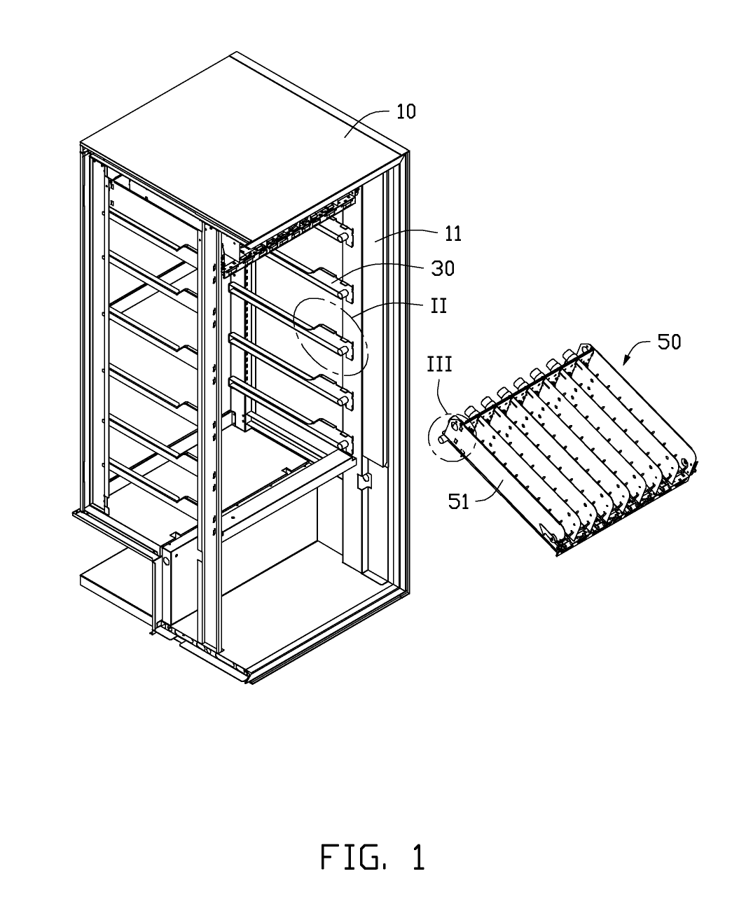

FIG. 1 illustrates an isometric, exploded view of a vending machine. The vending machine includes a rack 10, a plurality of pairs of slides 30 located in the rack 10, and a tray 50. The tray 50 is used to load different types of goods.

The rack 10 includes four stand columns 11. The plurality of pairs of slides 30 is mounted to the four stand columns 11.

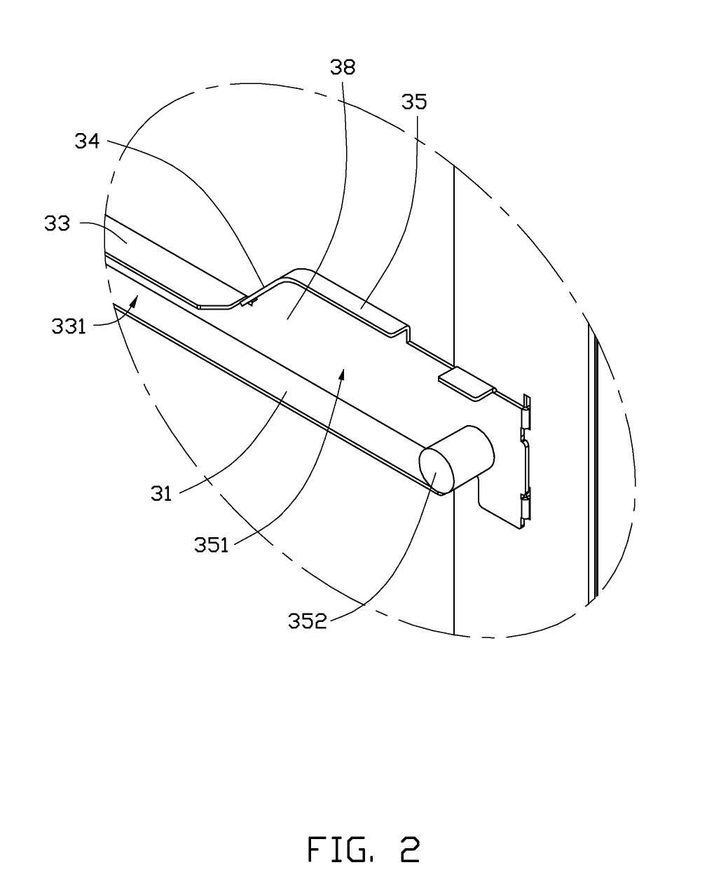

FIG. 2 illustrates an enlarged portion II of the vending machine of FIG. 1. Each of the plurality of pairs of slides 30 includes a side wall 38, a bottom flange 31, a first top flange 33, a second top flange 35, and a connecting flange 34. The bottom flange 31, the first top flange 33, the second top flange 35, and the connecting flange 34 are substantially parallel to the side wall 38. The first top flange 33 and the second top flange 35 extend along a substantially straight direction. The bottom flange 31 is substantially parallel to the first top flange 33 and the second top flange 35. A first distance between the bottom flange 31 and the first top flange 33 being smaller than a second distance between the bottom flange 31 and the second top flange 35. A first slideway 331 is defined between the bottom flange 31 and the first top flange 33. A second slideway 351 is defined between the bottom flange 31 and the second top flange 35. The first slideway 331 communicates with the second slideway 351. A stop tab 352 is located in the second slideway 351 adjacent to the bottom flange 31. The stop tab 352 is a cylinder. The connecting flange 34 connects the first top flange 33 and the second top flange 35, and is oblique relative to the first top flange 33 and the second top flange 35. The connecting flange 34 has round corners at two joint points of the first top flange 33 and the second top flange 35.

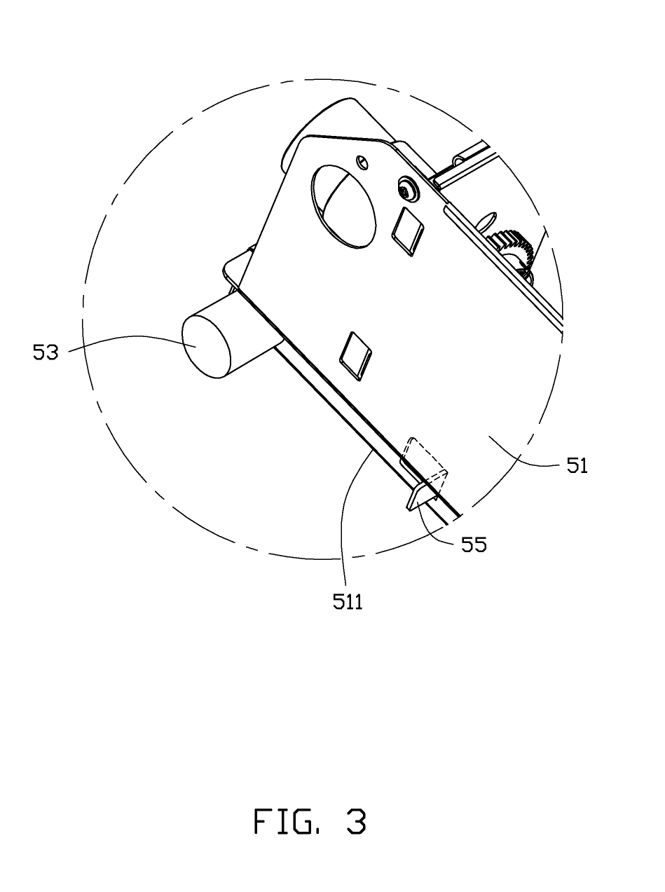

FIG. 3 illustrates an enlarged portion III of the vending machine of FIG. 1. The tray 50 includes a tray body 51 and a bottom plate 511. An end post 53 and a block tab 55 are located on the bottom plate 511. The block tab 55 is a bent from the bottom plate 511. The end post 53 and the block tab 55 are located on a lengthwise direction of the bottom plate 511. A distance between the end post 53 and the block tab 55 is smaller than a length of the bottom plate 511.

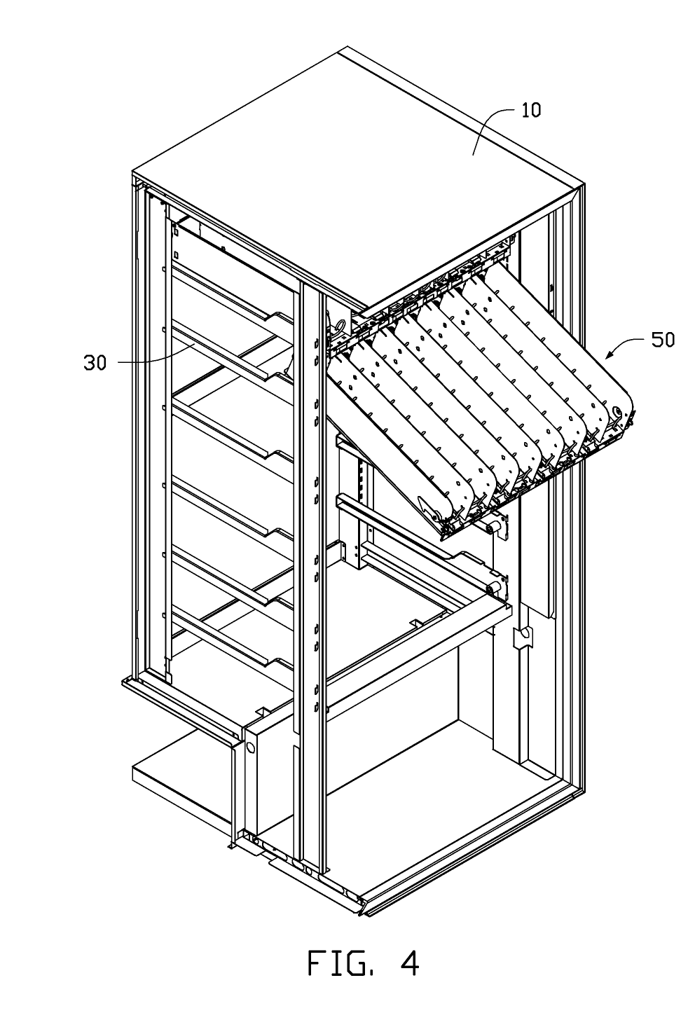

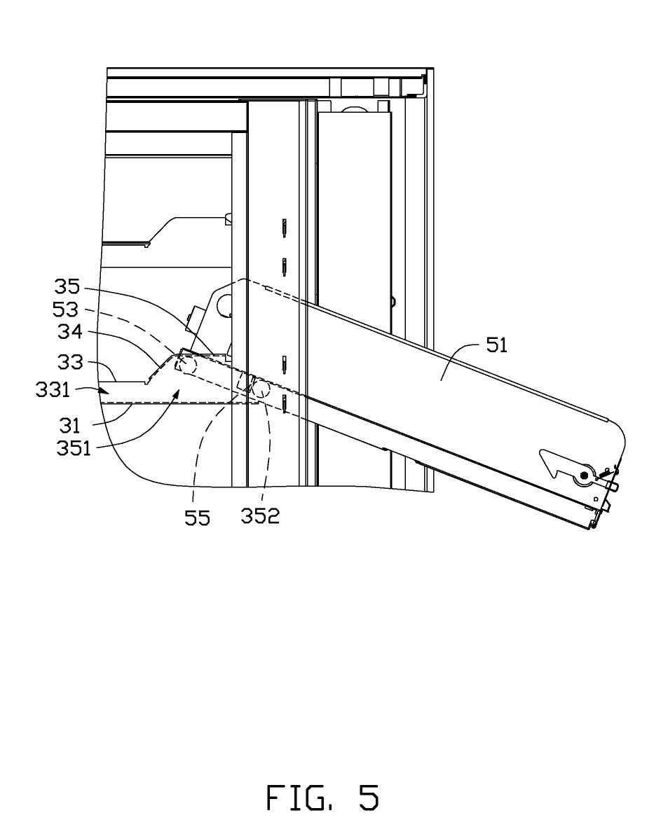

FIG. 4 and FIG. 5 illustrate two assembled views of the rack 10, the plurality of slides 30, and the tray 50. In assembly, the end post 53 and block tab 55 are guided into the first slideway 331 from the second slideway 351. The tray 50 is slideable relative to the slide 30. The tray 50 is substantially horizontal. The bottom plate 511 abuts the bottom flange 31.

When loading goods to the tray 50, the tray 50 is drawn out of the rack 10. The end post 53 is moved from the first slideway 331 to the second slideway 351. The tray 50 is oblique due to gravity. A rear end of the tray 50 with the end post 53 is lift up. The end post 53 moves to the second top flange 35 along the connecting flange 34 until the stop tab 352 blocks the block tab 55. The tray 50 is released, the end post 53 abuts the second top flange 35, and the tray 50 stops in that state. A rear portion of the tray 50 can be loaded.

When removing the tray 50 from the slide 30, the tray 50 is lifted to disengage the block tab 55 from the stop tab 352. The tray 50 is pulled outward and is removed from the slide 30 for maintaining.

An oblique angle of the tray 50 can be adjusted by redefining the vertical distance between the bottom flange 31 and the second top flange 35, or the distance between the block tab 55 and the end post 53.

The connecting flange 34 can be wavy or arcuate. The stop tab 352 can be piece or other shaped protrusion.

In other embodiments, the stop tab 352 can be changed to a fraction component located on a surface of the bottom flange 31 engaging with the block tab 55 stopping the tray 50.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine, comprising:
a rack;
a pair of slides; each of the slides comprises a bottom flange, a first top flange, and a second top flange; the first top flange connected to the second top flange, the bottom flange being substantially parallel to the first top flange; a first slideway defined between the bottom flange and the first top flange, a second slideway defined between the bottom flange and the second top flange; and a stop tab being located in the second slideway; and a first distance between the bottom flange and the first top flange being smaller than a second distance between the bottom flange and the second top flange; and
a tray movable along the pair of slides, and the tray comprises a block tab and an end post;
wherein when the end post is movable from the first slideway to the second slideway; in the first slideway, the end post abuts the first top flange; and in the second slideway, the end post abuts the second top flange, the stop tab blocks the block tab, and the tray is oblique.

2. The vending machine of claim 1, wherein each of the pair of slides further comprises a connecting flange located between the first top flange and the second top flange, and the connecting flange is oblique relative to the first top flange.

3. The vending machine of claim 1, wherein the second top flange extends along a straight direction, and the first top flange is substantially parallel to the second top flange.

4. The vending machine of claim 1, wherein a vertical distance between the bottom flange and the second top flange is smaller than a distance between the end post and the block tab.

5. The vending machine of claim 1, wherein the tray comprises a bottom plate, the end post and the block tab are located on a lengthwise direction of the bottom plate, and a distance between the end post and the block tab is smaller than a length of the bottom plate.

6. The vending machine of claim 1, wherein the stop tab is adjacent to the bottom flange.

7. The vending machine of claim 1, wherein the stop tab is a cylinder.

8. The vending machine of claim 1, wherein the block tab is bent from the tray.

9. A vending machine, comprising:
a rack;
a pair of slides; a first slideway and a second slideway defined in each of the slides, the first slideway being communicated with the second slideway; and a stop tab being located in the second slideway; and
a tray movable along the pair of slides, the tray comprises a block tab and an end post;
wherein when the end post is movable from the first slideway to the second slideway; in the first slideway, the end post and the block tab are restricted, and the tray is substantially horizontal; and in the second slideway, the stop tab blocks the block tab, the end post is lift up by the tray, and the tray is oblique.

10. The vending machine of claim 9, wherein each of the slides comprises a bottom flange, a first top flange, and a second top flange, the first top flange is connected to the second top flange, the bottom flange is substantially parallel to the first top flange, the first slideway is defined between the bottom flange and the first top flange, and the second slideway is defined between the bottom flange and the second top flange.

11. The vending machine of claim 10, wherein each of the pair of slides further comprises a connecting flange located between the first top flange and the second top flange, and the connecting flange is oblique relative to the first top flange.

12. The vending machine of claim 10, wherein the second top flange extends along a straight direction, and the first top flange is substantially parallel to the second top flange.

13. The vending machine of claim 10, wherein a vertical distance between the bottom flange and the second top flange is smaller than a distance between the end post and the block tab.

14. The vending machine of claim 10, wherein the stop tab is adjacent to the bottom flange.

15. The vending machine of claim 9, wherein the tray comprises a bottom plate, the end post and the block tab are located on a lengthwise direction of the bottom plate, and a distance between the end post and the block tab is smaller than a length of the bottom plate.

16. The vending machine of claim 9, wherein the stop tab is a cylinder.

17. The vending machine of claim 9, wherein the block tab is bent from the tray.
